(19) United States
(12) Patent Application Publication
(10) Pub. No.: US 2025/0038547 A1
(43) Pub. Date: Jan. 30, 2025

(54) POWER MODULE

(71) Applicant: ASUSTEK COMPUTER INC., Taipei (TW)

(72) Inventor: Kuang-Hui HSIAO, Taipei (TW)

(21) Appl. No.: 18/501,313

(22) Filed: Nov. 3, 2023

(30) Foreign Application Priority Data
Jul. 25, 2023 (TW) 112127676

(51) Int. Cl. H02J 7/00

(52) U.S. Cl. CPC H02J 7/0016; H02J 7/0025; H02J 7/0034

(57) ABSTRACT

The disclosure provides a power module, including a first power input/output (I/O), a second power I/O, a first battery unit, a second battery unit, and a control unit. A first current path and a second current path extend from the first power I/O to the second power I/O. A third current path extends from the first current path to the second current path. The first battery unit is disposed on the first current path. The second battery unit is disposed on the second current path and is electrically connected to the first battery unit in serial through the third current path. A first switch, a second switch and a third switch are respectively disposed on the first current path, the second current path, and the third current path. The control unit receives a control signal to control conductive states of the first switch, the second switch, and the third switch.

### CROSS-REFERENCE TO RELATED APPLICATION

This application claims the priority benefit of Taiwan Application Serial No. 112127676, filed on Jul. 25, 2023. The entirety of the above-mentioned patent application is hereby incorporated by reference herein and made a part of specification.

### BACKGROUND OF THE INVENTION

### Field of the Invention

The disclosure relates to a power module, and in particular, to a power module having a plurality of battery units.

### Description of the Related Art

Notebook computers are equipped with batteries as backup power to meet the needs of portable. After the notebook computer is plugged into a charger, power from the charger is used for charging the battery in addition to providing a system operation.

Battery configurations in current notebook computers are nothing more than series or parallel architectures. An output voltage of the battery configuration of the parallel architecture is low. When adapter connection does not exist, a loss of voltage conversion can be reduced, which is beneficial to prolong a battery life. However, the battery configuration of the parallel architecture requires to provide a large charging current during charging, and component specifications of the charging circuit are required to be high, otherwise a risk of overheating exists.

### BRIEF SUMMARY OF THE INVENTION

The disclosure provides a power module. The power module includes a first power I/O, a second power I/O, a first current path, a second current path, a third current path, a first battery unit, a second battery unit, a first switch, a second switch, a third switch, and a control unit. A first current path and a second current path extend from the first power I/O to the second power I/O. A third current path extends from the first current path to the second current path. The first battery unit is disposed on the first current path. The second battery unit is disposed on the second current path, and is electrically connected to the first battery unit in serial through the third current path. A first switch is disposed on the first current path. A second switch is disposed on the second current path. A third switch is disposed on the third current path. The control unit is configured to receive a control signal and control conductive states of the first switch, the second switch, and the third switch based on the control signal. When the control signal is a discharging signal, the control unit turns on the first switch and the second switch and turns off the third switch, so that the first battery unit and the second battery unit are respectively discharged through the first current path and the second current path; and when the control signal is a charging signal, the control unit turns off the first switch and the second switch and turns on the third switch, so that the first battery unit and the second battery unit are connected in series between the first power I/O and the second power I/O for charging.

Through the power module provided in the disclosure, the first battery unit and the second battery unit can be discharged in parallel during discharge, and the first battery unit and the second battery unit can be charged in series during charging. In this way, the battery configuration of the parallel architecture can have advantages of a discharging operation, while avoiding the need for a large charging current for the battery configuration of the parallel architecture, and reducing a risk of overheating of a charging line.

### BRIEF DESCRIPTION OF THE DRAWINGS

FIG. 1 is a schematic diagram of a power module according to an embodiment of the disclosure.

FIG. 2 shows a first current path of the power module in FIG. 1.

FIG. 3 shows a second current path of the power module in FIG. 1.

FIG. 4 shows a third current path of the power module in FIG. 1.

FIG. 5 is a schematic diagram of a discharging mode of the power module in FIG. 1.

FIG. 6 is a schematic diagram of a charging mode of the power module in FIG. 1.

FIG. 7 is a schematic diagram of a power module according to another embodiment of the disclosure.

FIG. 8 is a schematic diagram of a power module according to still another embodiment of the disclosure.

FIG. 9 shows an embodiment of a discharging control flow of a control unit.

FIG. 10A and FIG. 10B show another embodiment of a discharging control flow of a control unit.

FIG. 11A and FIG. 11B show still another embodiment of a discharging control flow of a control unit.

### DETAILED DESCRIPTION OF THE EMBODIMENTS

Advantages and features of the disclosure will be clearer based on the following descriptions and claims. Advantages and features of the disclosure will be clearer based on the following descriptions and claims. It should be noted that all the figures are in a very simple form and in an inaccurate proportion, and are merely intended to assist description of the purpose of the embodiments of the disclosure conveniently and clearly.

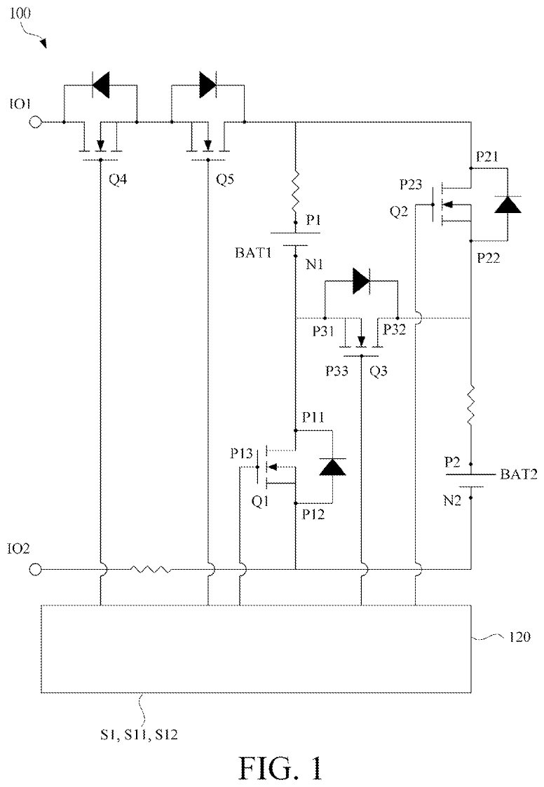

FIG. 1 is a schematic diagram of a power module 100 according to an embodiment of the disclosure.

As shown in the figure, the power module 100 includes a first power I/O IO1, a second power I/O IO2, a first battery unit BAT1, a second battery unit BAT2, a first switch Q1, a second switch Q2, a third switch Q3, and a control unit 120.

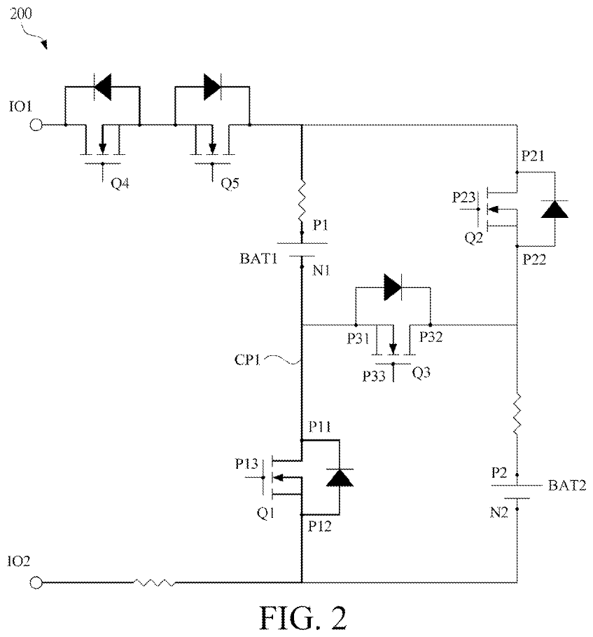

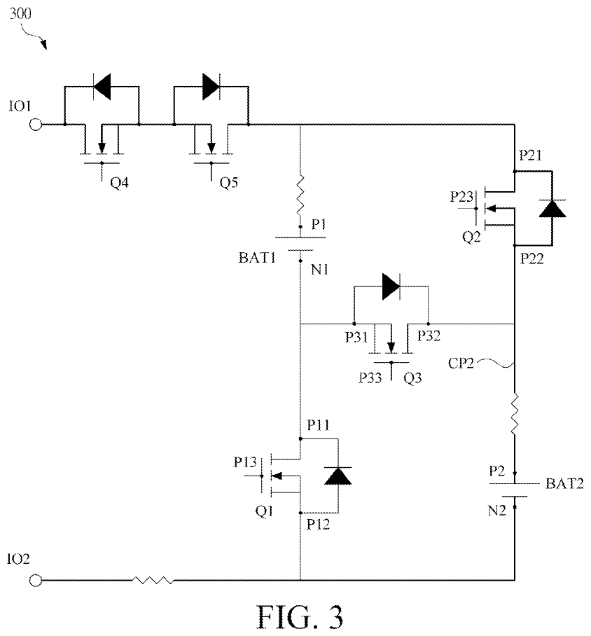

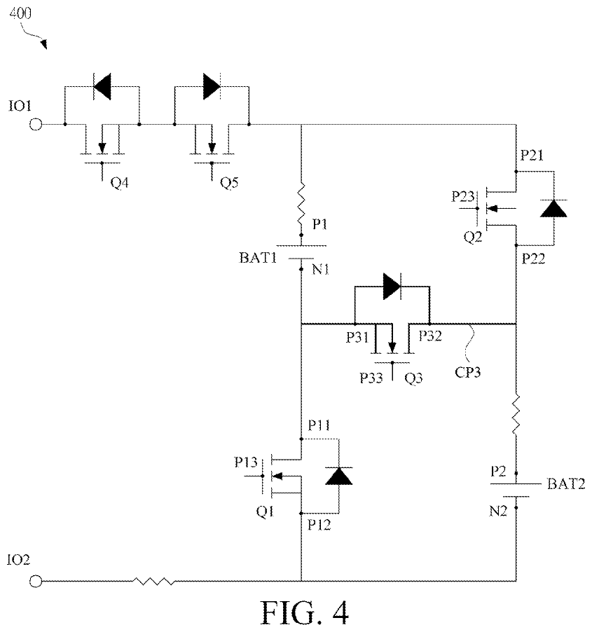

Referring to FIG. 2 to FIG. 4, the power module 100 has three power paths. FIG. 2 shows a first current path CP1 of the power module 100 in FIG. 1. FIG. 3 shows a second current path CP2 of the power module 100 in FIG. 1. FIG. 4 shows a third current path CP3 of the power module 100 in FIG. 1.

The first current path CP1 extend from the first power I/O IO1 to the second power I/O 102. The second current path CP2 extend from the first power I/O IO1 to the second power I/O IO2. The first current path CP1 and the second current path CP2 form a parallel circuit architecture. A third current path CP3 extends from the first current path CP1 to the second current path CP2.

The first battery unit BAT1 is disposed on the first current path CP1. The second battery unit BAT2 is disposed on the second current path CP2, and is electrically connected to the first battery unit BAT1 in serial through the third current path CP3. A rated voltage of the first battery unit BAT1 is the same as a rated voltage of the second battery unit BAT2.

The first switch Q1 is disposed on the first current path CP1. The second switch Q2 is disposed on the second current path CP2. The third switch Q3 is disposed on the third current path CP3. The control unit 120 receives a control signal S1 and controls conductive states of the first switch Q1, the second switch Q2, and the third switch Q3 based on the control signal S1.

The following is a more detailed description of relative positions of elements of the power module 100 in the disclosure.

Referring to FIG. 1, the first battery unit BAT1 includes a first positive electrode P1 and a first negative electrode N1. The second battery unit BAT2 includes a second positive electrode P2 and a second negative electrode N2. The first switch Q1 is located on a circuit between the first negative electrode N1 and the second power I/O 102. The second switch Q2 is located on a circuit between the first power I/O IO1 and the second positive electrode P2. The third switch Q3 is located on a circuit between the first negative electrode N1 and the second positive electrode P2.

The first switch Q1 includes a first connecting terminal P11, a second connecting terminal P12, and a first control terminal P13. The second switch Q2 includes a third connecting terminal P21, a fourth connecting terminal P22, and a second control terminal P23. The third switch Q3 includes a fifth connecting terminal P31, a sixth connecting terminal P32, and a third control terminal P33.

The first connecting terminal P11 of the first switch Q1 is electrically connected to the first negative electrode N1, and the second connecting terminal P12 is electrically connected to the second power I/O IO2.

The third connecting terminal P21 of the second switch Q2 is electrically connected to the first power I/O 101, and the fourth connecting terminal P22 is electrically connected to the second positive electrode P2.

The fifth connecting terminal P31 of the third switch Q3 is electrically connected to the first negative electrode N1, and the sixth connecting terminal P32 is electrically connected to the second positive electrode P2.

The control unit 120 is electrically connected to the first control terminal P13, the second control terminal P23, and the third control terminal P33, and controls conductive states of the first switch Q1, the second switch Q2, and the third switch Q3 through the first control terminal P13, the second control terminal P23, and the third control terminal P33. In an embodiment, the control unit 120 may be a microcontroller.

In an embodiment, as shown in the figure, the power module 100 further includes a charging switch Q4 and a discharging switch Q5. The charging switch Q4 and the discharging switch Q5 are arranged on a joint end of the first current path CP1 and the second current path CP2 connected to the first power I/O IO1 to provide reverse current protection. In an embodiment, the charging switch Q4 and the discharging switch Q5 may be a back-to-back metal-oxide semiconductor field-effect transistor element. The control unit 120 is electrically connected to the charging switch Q4 and the discharging switch Q5 to control the conductive states.

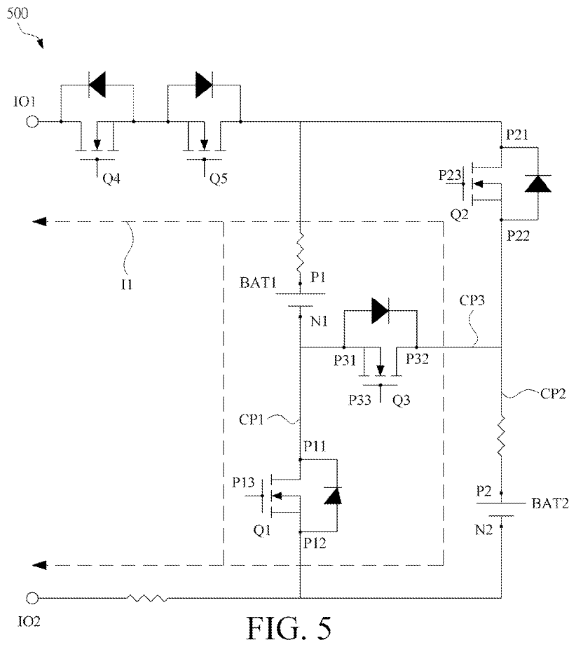

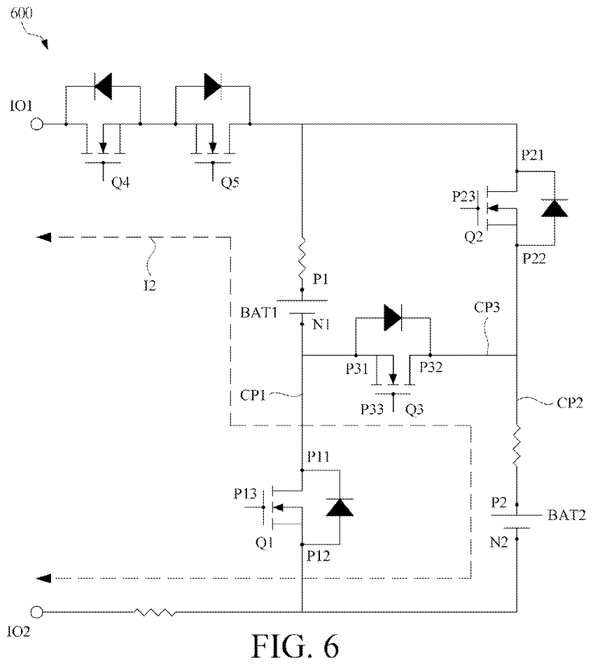

Referring to FIG. 5 and FIG. 6, FIG. 5 is a schematic diagram of a discharging mode of the power module 100 in FIG. 1. FIG. 6 is a schematic diagram of a charging mode of the power module 100 in FIG. 1.

As shown in FIG. 5, when the control signal S1 received by the control unit 120 is a discharging signal S11, the control unit 120 turns on the discharging switch Q5, the charging switch Q4, the first switch Q1, and the second switch Q2, and turns off the third switch Q3, so that the first battery unit BAT1 and the second battery unit BAT2 are respectively discharged through the first current path CP1 and the second current path CP2. The current path of the discharging current I1 is shown by the dashed line in the figure.

As shown in FIG. 6, when the control signal S1 received by the control unit 120 is a charging signal S12, the control unit 120 turns off the first switch Q1 and the second switch Q2, and turns on the discharging switch Q5, the charging switch Q4, and the third switch Q3, so that the first battery unit BAT1 and the second battery unit BAT2 are connected in series between the first power I/O IO1 and the second power I/O IO2. In this case, an external power can charge the first battery unit BAT1 and the second battery unit BAT2 connected in series through the third current path CP3. The current path of the charging current I2 is shown by the dashed line in the figure.

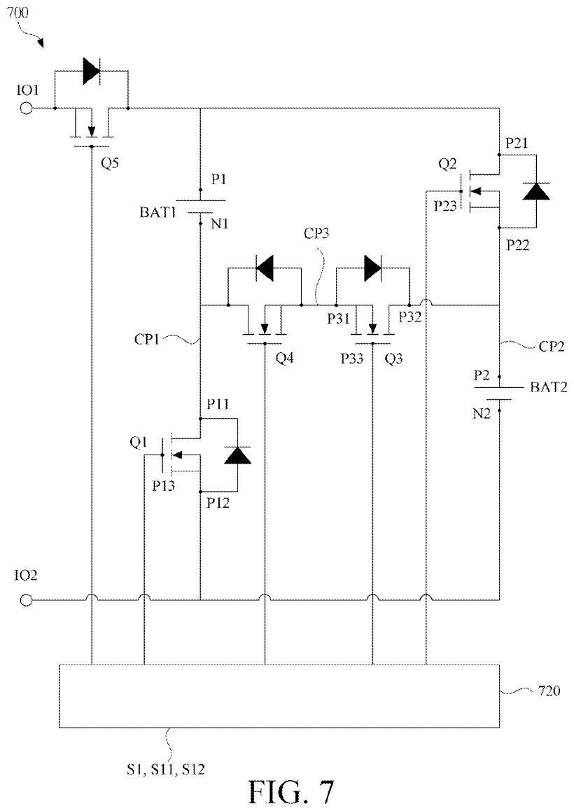

FIG. 7 is a schematic diagram of a power module 700 according to another embodiment of the disclosure.

Positions of the power module 700 of this embodiment are different from positions of the charging switch Q4 and the discharging switch Q5 in the embodiment of FIG. 1. The position of the discharging switch Q5 in this embodiment is similar to the embodiment of FIG. 1, and is maintained at one end of the first power I/O IO1 connected to the first current path CP1 and the second current path CP2, and the charging switch Q4 is disposed on the third current path CP3. In another embodiment, the discharging switch Q5 may be arranged at a joint end of the first current path CP1 and the second current path CP2 connected to the second power I/O IO2.

The control unit 720 controls conductive states of the first switch Q1, the second switch Q2, the third switch Q3, the charging switch Q4, and the discharging switch Q5 based on the control signal S1.

When the control signal S1 received by the control unit 720 is a discharging signal S11, the control unit 720 turns on the discharging switch Q5, the first switch Q1, and the second switch Q2, and turns off the third switch Q3 and the charging switch Q4, so that the first battery unit BAT1 and the second battery unit BAT2 are respectively discharged through the first current path CP1 and the second current path CP2. The discharging switch Q5 can provide reverse current protection for a discharging path of the power module 700 in the disclosure, to avoid damage to the discharging path.

In an embodiment, the charging switch Q4 and the third switch Q3 may be a back-to-back metal-oxide semiconductor field-effect transistor element. The back-to-back metal-oxide semiconductor field-effect transistor element (especially the metal-oxide semiconductor field-effect transistor element on the left) can provide reverse current protection for a charging path of the power module 700 in the disclosure to avoid damage to the charging path.

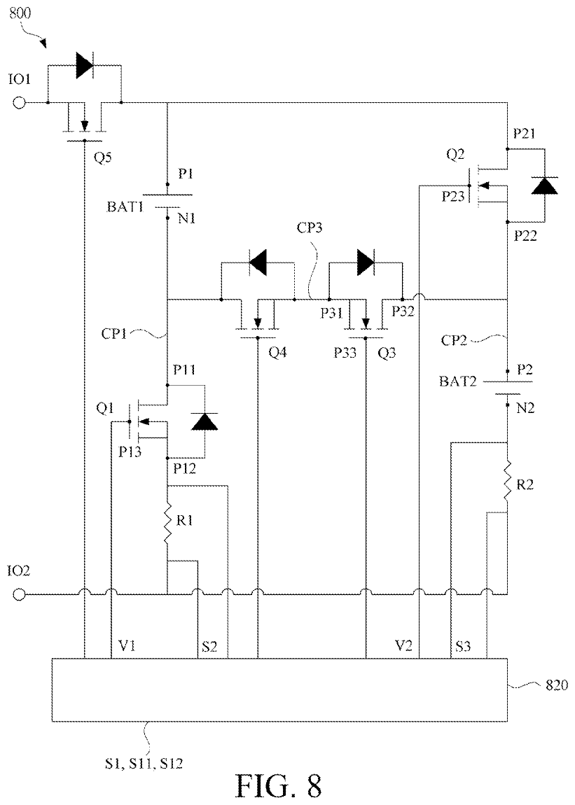

FIG. 8 is a schematic diagram of a power module 800 according to still another embodiment of the disclosure.

Compared with the embodiment of FIG. 1, the power module 800 of this embodiment further includes a first current detector R1 and a second current detector R2 to balance the current.

The first current detector R1 is arranged on the first current path CP1 and configured to detect a current on the first current path CP1 to generate a first current signal S2. The second current detector R2 is arranged on the second current path CP2 and configured to detect a current on the second current path CP2 to generate a second current signal S3. In an embodiment, the first current detector R1 may include a resistor, and the first current signal S2 is a pressure difference between two ends of the resistor. The second current detector R2 may include a resistor, and the second current signal S3 is a pressure difference between two ends of the resistor. However, the disclosure is not limited thereto. Another type of current detector, such as a magnetic field detection current detector, is also applicable to the disclosure.

When the control signal S1 received by the control unit 820 is the discharging signal S11, the control unit 820 generates a first control voltage V1 and a second control voltage V2 based on the first current signal S2 and the second current signal S3, which are respectively configured to control the on resistance of the first switch Q1 and the second switch Q2, and adjust the currents on the first current path CP1 and the second current path CP2.

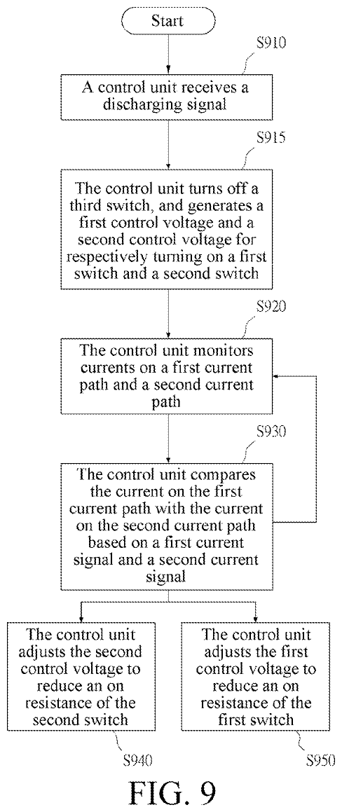

FIG. 9 shows an embodiment of a discharging control flow of a control unit 820. This embodiment is applicable to the power module 800 as shown in FIG. 8.

Firstly, as described in step S910, when the control signal S1 received by the control unit 820 is the discharging signal S11, the control unit 820 may turn off the third switch Q3, and generate a first control voltage V1 and a second control voltage V2 for respectively turning on the first switch Q1 and the second switch Q2.

Subsequently, as described in step S920, the control unit 820 may continuously monitor currents on the first current path CP1 and the second current path CP2. Next, as described in determining step S930, the control unit 820 may compare the current on the first current path CP1 with the current on the second current path CP2 based on the first current signal S2 and the second current signal S3.

When the current on the first current path CP1 is greater than the current on the second current path CP2, the flow proceeds to step S940. The control unit 820 adjusts the second control voltage V2 to reduce the on resistance of the second switch Q2, so that the current on the second current path CP2 may be increased. When the current on the first current path CP1 is less than the current on the second current path CP2, the flow proceeds to step S950. The control unit 820 adjusts the first control voltage V1 to reduce the on resistance of the first switch Q1. When the current on the first current path CP1 is equal to the current on the second current path CP2, the process returns to step S920 to continuously monitor the currents on the first current path CP1 and the second current path CP2.

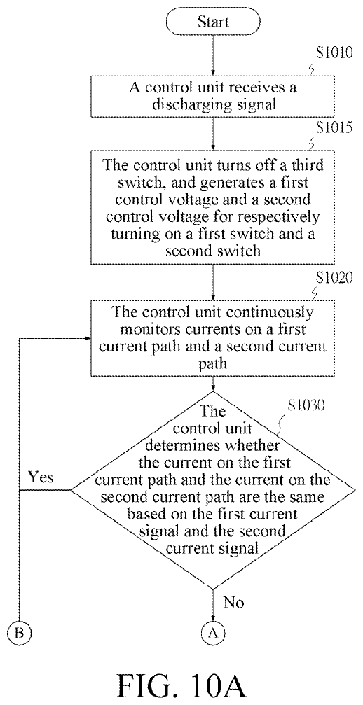

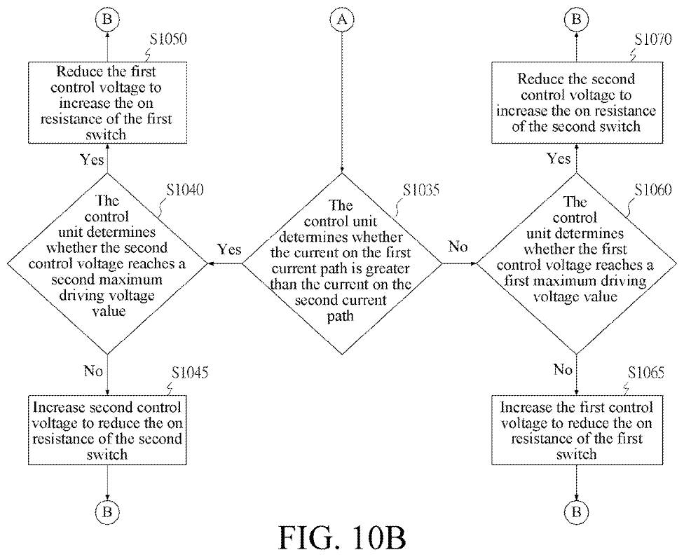

FIG. 10A and FIG. 10B show another embodiment of a discharging control flow of a control unit 820 according to the disclosure. This embodiment is applicable to the power module 800 shown in FIG. 8, in which the first switch Q1 and the second switch Q2 are both an N-type metal-oxide semiconductor field-effect transistor element. The first switch Q1 has a first maximum driving voltage value, and the second switch Q2 has a second maximum driving voltage value. The first maximum driving voltage value and the second maximum driving voltage value may be highest gate-source voltages that can be tolerated by the first switch Q1 and the second switch Q2 on the specification. The first switch Q1 needs to avoid receiving a driving voltage greater than the first maximum driving voltage value to avoid damage. The second switch Q2 needs to avoid receiving a driving voltage greater than the second maximum driving voltage value to avoid damage.

First, as described in step S1010, the control unit 820 receives the discharging signal S11. Subsequently, as described in step S1015, the control unit 820 may turn off the third switch Q3, and generate a first control voltage V1 and a second control voltage V2 for respectively turning on the first switch Q1 and the second switch Q2. The first control voltage V1 and the second control voltage V2 are respectively set to the first maximum driving voltage value and the second maximum driving voltage value to obtain a lowest on resistance and reduce discharging loss.

Subsequently, as described in step S1020, the control unit 820 may continuously monitor currents on the first current path CP1 and the second current path CP2. Next, as described in determining step S1030, the control unit 820 may determine whether the current on the first current path CP1 and the current on the second current path CP2 are the same based on the first current signal S2 and the second current signal S3. When the currents are the same, go back to step S1020, and the currents on the first current path CP1 and the second current path CP2 are continuously monitored.

When the current on the first current path CP1 is different from the current on the second current path CP2, the process proceeds to the determining step S1035, and it is determined whether the current on the first current path CP1 is greater than the current on the second current path CP2. When the current on the first current path CP1 is greater than the current on the second current path CP2, the process proceeds to the determining step S1040. When the current on the first current path CP1 is less than the current on the second current path CP2, the process proceeds to the determining step S1060.

In the determining step S1040, the control unit 820 determines whether the second control voltage V2 reaches the second maximum driving voltage value. When the second control voltage V2 does not reach the second maximum driving voltage value, the process proceeds to step S1045, where the second control voltage V2 is increased to reduce the on resistance of the second switch Q2. When the second control voltage V2 reaches the second maximum driving voltage value, the process proceeds to step S1050, where the first control voltage V1 is reduced to increase the on resistance of the first switch Q1.

In the determining step S1060, the control unit 820 determines whether the first control voltage V1 reaches the first maximum driving voltage value. When the first control voltage V1 does not reach the first maximum driving voltage value, the process proceeds to step S1065, and the first control voltage V1 is increased to reduce the on resistance of the first switch Q1. When the first control voltage V1 reaches the first maximum driving voltage value, the process proceeds to step S1070, where the second control voltage V2 is reduced to increase the on resistance of the second switch Q2.

Based on the above, the control logic of the control unit 820 for the current balance in the disclosure is as follows. When the current on the first current path CP1 is greater than the current on the second current path CP2 and the second control voltage V2 does not reach the second maximum driving voltage value, the second control voltage V2 is increased to reduce the on resistance of the second switch Q2. When the current on the first current path CP1 is greater than the current on the second current path CP2 and the second control voltage V2 reaches the second maximum driving voltage value, the first control voltage V1 is reduced to increase the on resistance of the first switch Q1. When the current on the first current path CP1 is less than the current on the second current path CP2 and the first control voltage V1 does not reach the first maximum driving voltage value, the first control voltage V1 is increased to reduce the on resistance of the first switch Q1. When the current on the first current path CP1 is less than the current on the second current path CP2 and the first control voltage V1 reaches the first maximum driving voltage value, the second control voltage V2 is reduced to increase the on resistance of the second switch Q2. When the current on the first current path CP1 is equal to the current on the second current path CP2, the first control voltage V1 and the second control voltage V2 are maintained.

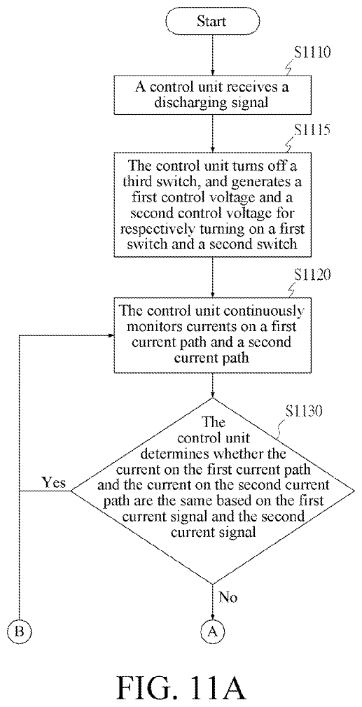

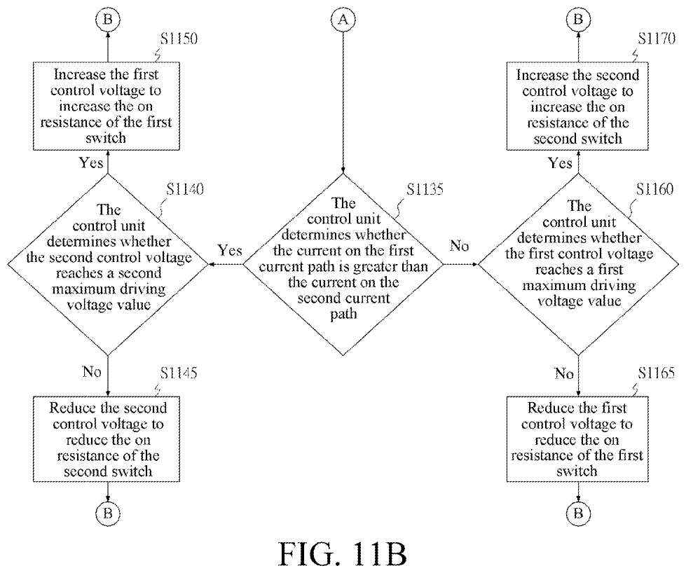

FIG. 11A and FIG. 11B show still another embodiment of a discharging control flow of a control unit 820 according to the disclosure. This embodiment is applicable to the power module 800 shown in FIG. 8, in which the first switch Q1 and the second switch Q2 are both a P-type metal-oxide semiconductor field-effect transistor element. The first switch Q1 has a first minimum driving voltage value, and the second switch Q2 has a second minimum driving voltage value.

The first minimum driving voltage value and the second minimum driving voltage value may be lowest gate-source voltages that can be tolerated by the first switch Q1 and the second switch Q2 on the specification. The first switch Q1 needs to avoid receiving a driving voltage less than the first minimum driving voltage value to avoid damage. The second switch Q2 needs to avoid receiving a driving voltage less than the second minimum driving voltage value to avoid damage.

First, as described in step S1110, the control unit 820 receives the discharging signal S11. Subsequently, as described in step S1115, the control unit 820 may turn off the third switch Q3, and generate a first control voltage V1 and a second control voltage V2 for respectively turning on the first switch Q1 and the second switch Q2. The first control voltage V1 and the second control voltage V2 are respectively set to the first minimum driving voltage value and the second minimum driving voltage value to obtain a lowest on resistance and reduce discharging loss.

Subsequently, as described in step S1120, the control unit 820 may continuously monitor currents on the first current path CP1 and the second current path CP2. Next, as described in determining step S1130, the control unit 820 may determine whether the current on the first current path CP1 and the current on the second current path CP2 are the same based on the first current signal S2 and the second current signal S3. When the currents are the same, go back to step S1120, and the currents on the first current path CP1 and the second current path CP2 are continuously monitored.

When the current on the first current path CP1 is different from the current on the second current path CP2, the process proceeds to the determining step S1135, and it is determined whether the current on the first current path CP1 is greater than the current on the second current path CP2. When the current on the first current path CP1 is greater than the current on the second current path CP2, the process proceeds to the determining step S1140. When the current on the first current path CP1 is less than the current on the second current path CP2, the process proceeds to the determining step S1160.

In the determining step S1140, the control unit 820 determines whether the second control voltage V2 reaches the second minimum driving voltage value. When the second control voltage V2 does not reach the second minimum driving voltage value, the process proceeds to step S1145, where the second control voltage V2 is reduced to reduce the on resistance of the second switch Q2. When the second control voltage V2 reaches the second minimum driving voltage value, the process proceeds to step S1150, where the first control voltage V1 is increased to increase the on resistance of the first switch Q1.

In the determining step S1160, the control unit 820 determines whether the first control voltage V1 reaches the first minimum driving voltage value. When the first control voltage V1 does not reach the first minimum driving voltage value, the process proceeds to step S1165, and the first control voltage V1 is reduced to reduce the on resistance of the first switch Q1. When the first control voltage V1 reaches the first minimum driving voltage value, the process proceeds to step S1170, where the second control voltage V2 is increased to increase the on resistance of the second switch Q2.

Based on the above, the control logic of the control unit 820 for the current balance in the disclosure is as follows. When the current on the first current path CP1 is greater than the current on the second current path CP2 and the second control voltage V2 does not reach the second minimum driving voltage value, the second control voltage V2 is reduced to reduce the on resistance of the second switch Q2. When the current on the first current path CP1 is greater than the current on the second current path CP2 and the second control voltage V2 reaches the second minimum driving voltage value, the first control voltage V1 is increased to increase the on resistance of the first switch Q1. When the current on the first current path CP1 is less than the current on the second current path CP2 and the first control voltage V1 does not reach the first minimum driving voltage value, the first control voltage V1 is reduced to reduce the on resistance of the first switch Q1. When the current on the first current path CP1 is less than the current on the second current path CP2 and the first control voltage V1 reaches the first minimum driving voltage value, the second control voltage V2 is increased to increase the on resistance of the second switch Q2. When the current on the first current path CP1 is equal to the current on the second current path CP2, the first control voltage V1 and the second control voltage V2 are maintained.

Through the power modules 100, 700, and 800 provided in the disclosure, the first battery unit BAT1 and the second battery unit BAT2 may be discharged in parallel during discharging, and the first battery unit BAT1 and the second battery unit BAT2 may be charged in series during charging. In this way, the battery configuration of the parallel architecture can have advantages of a discharging operation, while avoiding the need for a large charging current for the battery configuration of the parallel architecture, and reducing a risk of overheating of a charging line.

The above is merely preferred embodiments of the disclosure, and do not impose any limitation on the disclosure. Any form of change such as an equivalent replacement or modification made by any person skilled in the art to technical means and technical content provided in the disclosure without departing from scope of the technical means of the disclosure is content that does not deviate from the technical means of the disclosure, and still falls within protection scope of the disclosure.

What is claimed is:

1. A power module, comprising:
a first power input/output (I/O);
a second power I/O;
a first current path, extending from the first power I/O to the second power I/O;
a second current path, extending from the first power I/O to the second power I/O;
a third current path, extending from the first current path to the second current path;
a first battery unit, disposed on the first current path;
a second battery unit, disposed on the second current path and electrically connected to the first battery unit in serial through the third current path;
a first switch, disposed on the first current path;
a second switch, disposed on the second current path;
a third switch, disposed on the third current path; and
a control unit, configured to receive a control signal and control conductive states of the first switch, the second switch, and the third switch based on the control signal, wherein
when the control signal is a discharging signal, the control unit turns on the first switch and the second switch and turns off the third switch, so that the first battery unit and the second battery unit are respectively discharged through the first current path and the second current path; and when the control signal is a charging signal, the control unit turns off the first switch and the second switch and turns on the third switch, so that the first battery unit and the second battery unit are connected in series between the first power I/O and the second power I/O for charging.

2. The power module according to claim 1, wherein the first battery unit comprises a first positive electrode and a first negative electrode, the second battery unit comprises a second positive electrode and a second negative electrode, the first switch is located on a circuit between the first negative electrode and the second power I/O, the second switch is located on a circuit between the first power I/O and the second positive electrode, and the third switch is located on a circuit between the first negative electrode and the second positive electrode.

3. The power module according to claim 2, wherein the first switch comprises a first connecting terminal, a second connecting terminal, and a first control terminal, the second switch comprises a third connecting terminal, a fourth connecting terminal, and a second control terminal, the third switch comprises a fifth connecting terminal, a sixth connecting terminal, and a third control terminal, the first connecting terminal is electrically connected to the first negative electrode, the second connecting terminal is electrically connected to the second power I/O, the third connecting terminal is electrically connected to the first power I/O, the fourth connecting terminal is electrically connected to the second positive electrode, the fifth connecting terminal is electrically connected to the first negative electrode, the sixth connecting terminal is electrically connected to the second positive electrode, and the control unit is electrically connected to the first control terminal, the second control terminal, and the third control terminal, and is configured to control the conductive states of the first switch, the second switch, and the third switch through the first control terminal, the second control terminal, and the third control terminal.

4. The power module according to claim 1, further comprising a discharging switch arranged at a joint end of the first current path and the second current path connected to the first power I/O or the second power I/O, wherein when the control signal is a discharging signal, the control unit turns on the discharging switch.

5. The power module according to claim 1, further comprising a charging switch arranged on the third current path.

6. The power module according to claim 5, wherein the charging switch and the third switch form a back-to-back metal-oxide semiconductor field-effect transistor element.

7. The power module according to claim 1, wherein a rated voltage of the first battery unit is the same as a rated voltage of the second battery unit.

8. The power module according to claim 1, further comprising:
a first current detector, arranged on the first current path and configured to detect a current on the first current path to generate a first current signal; and
a second current detector, arranged on the second current path and configured to detect a current on the second current path to generate a second current signal.

9. The power module according to claim 8, wherein the control unit is configured to: generate a first control voltage and a second control voltage for respectively turning on the first switch and the second switch, and adjust voltage levels of the first control voltage and the second control voltage based on the first current signal and the second current signal.

10. The power module according to claim 9, wherein the control unit is configured to:
compare the current on the first current path with the current on the second current path based on the first current signal and the second current signal;
adjust the second control voltage to reduce an on resistance of the second switch when the current on the first current path is greater than the current on the second current path; and
adjust the first control voltage to reduce an on resistance of the first switch when the current on the first current path is less than the current on the second current path.

11. The power module according to claim 9, wherein the first switch and the second switch are both an N-type metal-oxide semiconductor field-effect transistor element, the first switch has a first maximum driving voltage value, the second switch has a second maximum driving voltage value, and the control unit is configured to:
compare the current on the first current path with the current on the second current path based on the first current signal and the second current signal;
increase the second control voltage to reduce an on resistance of the second switch when the current on the first current path is greater than the current on the second current path and the second control voltage does not reach the second maximum driving voltage value;
reduce the first control voltage to increase an on resistance of the first switch when the current on the first current path is greater than the current on the second current path and the second control voltage reaches the second maximum driving voltage value;
increase the first control voltage to reduce the on resistance of the first switch when the current on the first current path is less than the current on the second current path and the first control voltage does not reach the first maximum driving voltage value; and
reduce the second control voltage to increase the on resistance of the second switch when the current on the first current path is less than the current on the second current path and the first control voltage reaches the first maximum driving voltage value.

12. The power module according to claim 9, wherein the first switch and the second switch are both a P-type metal-oxide semiconductor field-effect transistor element, the first switch has a first minimum driving voltage value, the second switch has a second minimum driving voltage value, and the control unit is configured to:
compare the current on the first current path with the current on the second current path based on the first current signal and the second current signal;
reduce the second control voltage to reduce an on resistance of the second switch when the current on the first current path is greater than the current on the second current path and the second control voltage does not reach the second minimum driving voltage value;
increase the first control voltage to increase an on resistance of the first switch when the current on the first current path is greater than the current on the second current path and the second control voltage reaches the second minimum driving voltage value;
reduce the first control voltage to reduce the on resistance of the first switch when the current on the first current path is less than the current on the second current path and the first control voltage does not reach the first minimum driving voltage value; and
increase the second control voltage to increase the on resistance of the second switch when the current on the first current path is less than the current on the second current path and the first control voltage reaches the first minimum driving voltage value.

13. The power module according to claim 1, wherein the control unit is a microcontroller.
